(19) United States
(12) Patent Application Publication
(10) Pub. No.: US 2006/0264294 A1
(43) Pub. Date: Nov. 23, 2006

(54) Hypocycloidal drive unit for conversion of rotary to linear motion particularly for use in fiberglass insulation production machinery

(76) Inventors: David L. Summa, Smithville, MO (US); Michael O. Moore, Shawnee, KS (US)

Correspondence Address: Wm. Bruce Day;DAY LAW FIRM, P.C., Suite 300, 4330 Belleview, Kansas City, MO, 64111-3579, US

(21) Appl. No.: 11/131,819

(22) Filed: May 18, 2005

(51) Int. Cl. F16H 37/02; F02B 75/32

(52) U.S. Cl. 475/210; 123/197.1

(57) ABSTRACT

A hypocycloidal drive unit converts rotary to linear motion for use in high speed, high volume repetitive operations such as folding and lifting operations in the fiberglass insulation production industry. The drive unit is of low cost and low maintenance construction using a ring assembly with an inner planet wheel. An eccentric arm extends from the planet wheel and connects to crank arms joined to a lift arm which linearly and reciprocatingly slides in guides. The drive unit is characterized by the absence of gear teeth on the inner surface of the ring and on the planet wheel outer diameter. Various embodiments are disclosed including a circumferential chain around the ring and an inner planet wheel sprocket engaging the chain, a smooth inner ring circumferential surface and rubber faced planet wheel or tire traveling around the inner ring and an elastomeric cog belt and toothed planet wheel. The drive unit is able to withstand high cycle rates of up and down lift cycles per second during continuous operation.

### FIELD OF THE INVENTION

This invention relates to a hypocycloidal drive unit and, more specifically, one which is designed for inexpensive fabrication and continuous, high speed, high cycle rate operation for use in production line machinery operating in a dirty environment likely to cause clogging of conventional equipment.

### BACKGROUND OF THE INVENTION

Planocentric hypocycloidal drive units are used for speed reduction and when coupled to an eccentric drive, provide rotary to linear motion conversion. These units generally comprise an input shaft coupled to a driving motor, typically an electric motor. The input shaft extends into a fly wheel having a counterweight and a planet gear wheel diametrically opposed to the weight and eccentrically mounted upon the fly wheel. The fly wheel is surrounded by an outer, fixed, ring gear with teeth cut into the inner circumference surface of the ring gear. The planet gear has an outer circumference with teeth cut to match the ring gear teeth so that the planet wheel travels around the inside circumference of the ring gear as the fly wheel rotates.

A crank arm extends eccentrically of the center axis of the planet gear and connects to a swing arm which in turn is swingably connected to a reciprocating shaft held to linear travel by slide guides or ways.

A recurrent difficulty with hypocycloidal drive units is that the gear mechanism is expensive to produce and is normally created by gear machining operations. Gear trains have lubrication requirements and wear quickly if not lubricated or if the oil breaks down or becomes contaminated. In a system requiring many linear actuators, gear train hypocycloidal drive units can add significant cost. Moreover, maintenance requires continued expense. As an alternative to the high cost of these gear units, fluid power rams are sometimes used. These can be pneumatically or hydraulically actuated but such fluid power ram units are not suitable for high speed, continuous operation because the ram cylinder seals wear, resulting in leaks and maintenance downtime. Pneumatic power is preferred over pressurized oil fluid power because of its faster response time; however, pneumatic rams are noisy, caused by the release of air pressure as the ram cycles. In a production plant with many pneumatic devices cycling continuously, the noise level can become quite high, in addition to the seal leakage/maintenance problem.

As a result, there has been a need to provide a low cost, power efficient, low maintenance, high volume, rapid cycle, rotary to linear power conversion device. Sturdiness in use is particularly important because any downtime in a high speed production line is costly in both lost production time and idle labor.

### SUMMARY OF THE INVENTION

It is in view of the above problems that the present invention was created. The invention is a hypocycloidal drive unit that converts rotary to linear movement. The drive unit is of relatively low cost yet is exceedingly sturdy in use. It requires little maintenance and is capable of extended use without maintenance or with minimal maintenance at a rapid cycle rate of at least one (1) cycle per second. In testing, the unit ran 1,100,00 cycles for a 38 day period without maintenance and without fault. A particular use for the invention is as a lift drive mechanism for stacking batts of fiberglass insulation as provided in KCI's co-pending patent application for Insulation Batt Stacking, Packing and Bagging Tower wherein the batt lift mechanism has a speed of one (1) cycle per second.

The invention is a hypocycloidal drive mechanism having a ring assembly with an inner planet member. An eccentric pin extends from the planet member and connects to a crank arm joined to a lift arm linearly and reciprocatingly sliding in guides or ways. The gear box assembly in which the planet member rides is characterized by the absence of steel cut gear teeth on the inner surface of the ring housing and on the planet member outer circumference. In a preferred embodiment, the inner circumference of the ring housing is defined by a broad chain with multiple links and rollered pins which is secured and stretched snugly around a pair of spaced discs so as to define a channel between the discs. The planet wheel has sprocket teeth and is mounted on an arm extending diametrically from the fly wheel counterweight. As the fly wheel spins, the planet wheel rotates in engagement with the chain. This causes the lift arm to move up and down. The chain requires little lubrication. In the dirty and high lint environment of a glass fiber batt insulation production facility, fibers or chunks of fiber insulation that fall into the ring housing do not clog and catch but are pushed outwardly through the holes in the chain. The chain also flexes as the planet sprocket revolves and travels around the ring housing interior, further reducing otherwise destructive stress on the meshing elements.

Alternative embodiments to the hypocycloidal drive unit include a smooth surface ring inner diameter and a rubber tired planet wheel. This structure runs exceedingly quiet and is also well suited for the high lint/fiber environment of a fiberglass production facility. If a piece of insulation falls into the drive unit, the rubber tire, because it is not in meshing engagement with a gear train system, simply accommodates the insulation fragment without clogging.

In all cases, the ratio of the interior diameter of the ring housing to the outside diameter of the planet wheel must be 2:1 to achieve true linear motion.

### OBJECTS OF THE INVENTION

The objects of the present invention are:

To provide a drive unit which is capable of inexpensive manufacture;

To provide such a drive unit that is capable of extended operation at high rates of cycles per minute while requiring little or no maintenance;

To provide such a drive unit which is capable of extended, continuous operation in a dirty industrial plant environment such that it can be substantially self-cleaning;

To provide a drive unit which is particularly suited for use in a high speed fiberglass insulation production line; and

To provide such a drive unit which is ideally suited for the intended purpose.

Other objects and advantages will become apparent from the following description of the drawings.

### BRIEF DESCRIPTION OF THE DRAWINGS

FIG. 1 is an elevational view, partly in longitudinal section, of the hypocycloidal drive unit.

FIG. 2 is an end view of the drive shaft.

FIG. 3 is an end view showing rotation.

FIG. 4 is an end view showing rotation.

FIG. 5 is an end view of an alternative embodiment.

FIG. 6 is an end view of a second alternative embodiment.

### DETAILED DESCRIPTION OF THE PREFERRED AND ALTERNATE EMBODIMENTS

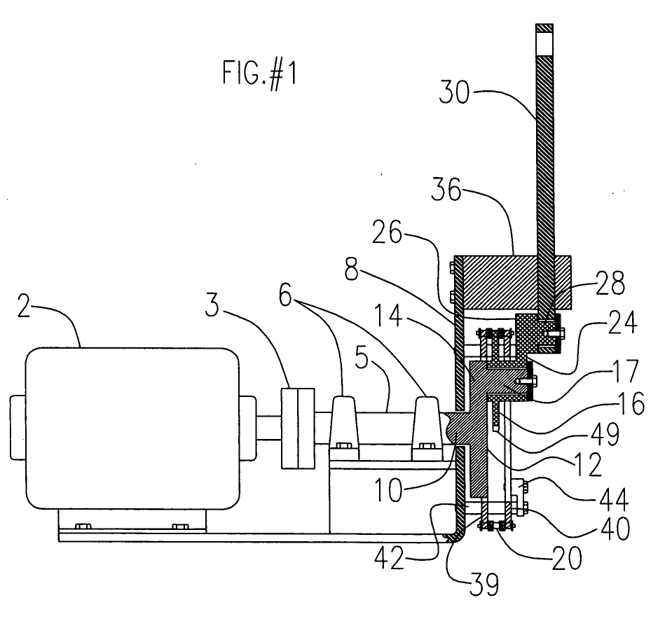

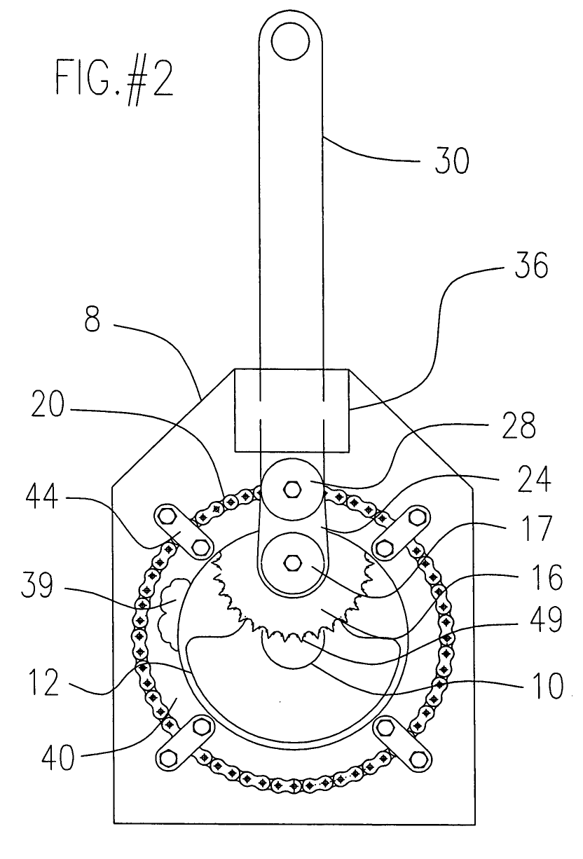

Referring to the accompanying drawings in which like reference numbers indicate like elements, FIG. 1 generally shows an exploded view of the hypocycloidal drive unit 1. FIG. 2 is an elevational view of a stacking, packing and bagging tower assembly in which the hypocycloidal drive unit is preferably used as the batt lift mechanism driver. In such an operation, the drive unit may cycle as many as one (1) cycle per second, with the production line running two shifts 16 hours per day, or even three shifts, seven days per week. With this high production rate and high line speed, reliability of operation is very important. Reliability refers both to robustness of the mechanical elements but also to design and component selection. A persistent problem in fiberglass insulation production plants has been the tendency of pieces of insulation and insulation fiber to break off and clog mechanical components. Fiber masses find their way into gear boxes, coat surfaces, short electric switches and cause a variety of problems for the manufacturer. With these challenges in mind, applicant, a manufacturer of equipment for the insulation production industry, has designed this invention.

The invention is a hypocycloidal drive unit 1 consisting of a source of power, such as an electric motor 2 driving an input shaft 5 supported by pillow blocks 6. The shaft 5 extends into a speed reduction assembly first having a backing plate 8 which, in the illustrated example, extends upwardly form the motor 2. A fly wheel 10 is affixed to the end of the input shaft 5 and rotates therewith. The fly wheel 10 has a counterweight portion 12 with a diametrically opposed arm portion 14 extending from the axis of the fly wheel 10. A planet wheel 16 is rotatably mounted to a pin 17 extending from an end of the arm portion 14. The planet wheel 16 travels around the inside circumference 20 of a ring member 22 in engagement therewith.

The planet wheel 16 has a crank arm 24 mounted to it and extending from the pin 17 to a termination end 26. The crank arm 24 does not rotate relative to the pin 17 but revolves as the pin 17 revolves as the planet wheel 16 travels about the inside of the ring member 22. A second pin 28 extends from the arm end 26 and is rotatably connected to a connecting rod 30. The connecting rod 30 rotates relative to the fixed position crank arm 24 as the planet wheel 16 travels. The connecting rod 30 is in turn swingably connected to a lift arm 35 mounted in slide guides or ways 36 to restrain the lift arm from side to side swinging movement. When so guided, all movement of the lift arm 35 is linear reciprocation at a speed directly proportioned to the rotational speed of the input shaft 5 and the relative diameter of the planet wheel 16 and the inside diameter 20 of the ring member 22. When correctly assembled, all rods and links are in a straight line relative to the guides 36, with the fly wheel 10 counterweight 12 opposite to the lift as in 35.

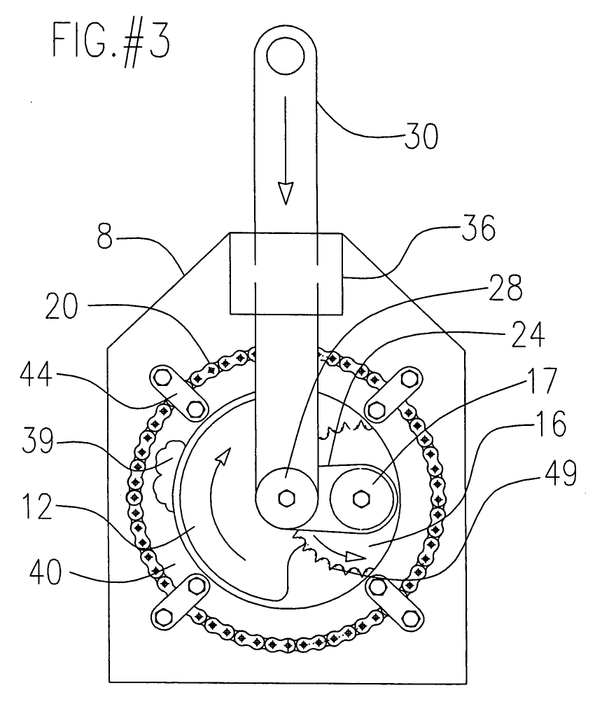

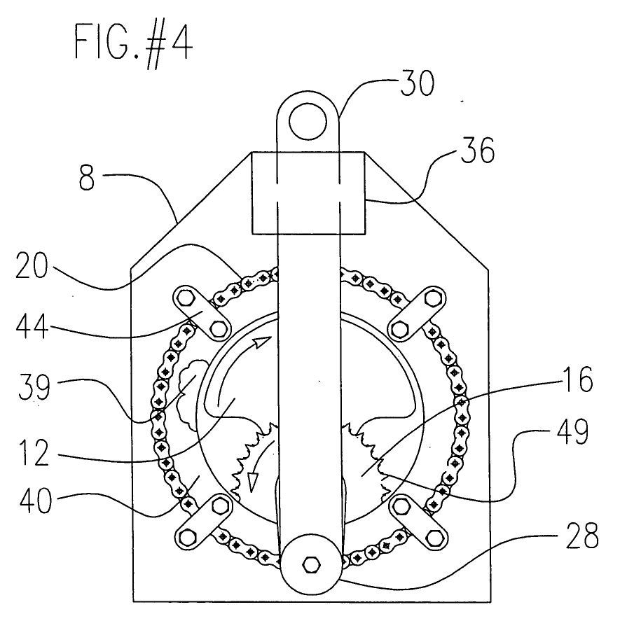

In the preferred embodiment of the invention shown in FIGS. 1 to 4, the ring member 22 is formed of front and back rings 39 and 40. The back ring 39 is attached to the backing plate 8 by bolts and spacers 42. The front ring 40 is attached to the backing plate 8 by L shaped brackets 44 so as to form a continuous, annular passage between the front and back rings 39 and 40. A link chain 45 such as a triple row chain, formed of robust links and roller pins to form cogs, encircles the rings 39 and 40 and is joined to them. The outer circumference surface of the rings 39 and 40 have sprocket teeth 47 formed in them and matching the pitch of the chain 45 so that the chain does not slip around the rings. The planet wheel 16 has sprocket teeth 49 which engage the chain 45 as the wheel 16 travels around between the rings 39 and 40. As the wheel 16 travels, the chain 45 flexes. Bits of foreign matter such as lint, dirt or pieces of insulation material tend to be pushed out though gaps in the chain and do not clog the mechanism unless unusually large or hard. The chain/sprocket wheel combination provides positive coupling engagement, is flexible to account for wear, is not particularly sensitive to lubrication requirements, accommodates foreign matter, is self-cleaning and is inexpensive to produce when compared to a machine cut gear pattern. FIGS. 2 through 4 show rotation of the parts and angular relations.

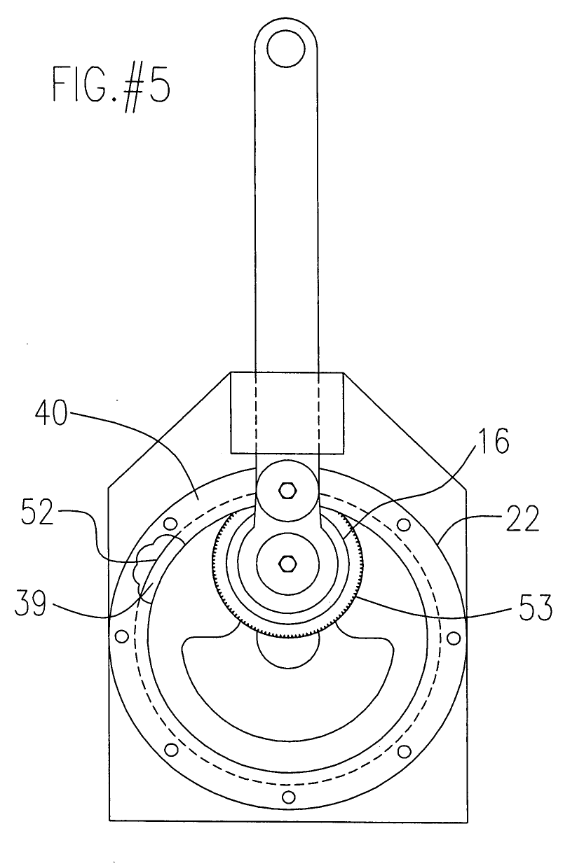

An alternative form of planet wheel 16 and ring member 22 engagement is shown in FIG. 5. Therein, the ring member 22, still having outer and inner rings 39 and 40 defining an annular channel therebetween, has a smooth, annular web 52 between the outer circumferential surfaces of the rings 39 and 40 to define a raceway therebetween. The planet wheel 16 has a smooth outer circumference with a gripping surface. In the alternative embodiment, the planet wheel 16 is a solid rubber tire 53. This structure is likewise inexpensive to produce, lubrication requirements are minimal, the arrangement accommodates dirt, lint, bits of insulation, and other foreign matter, and is exceedingly quiet in operation. The rubber tire structure offers the advantage of slipping if an obstruction is encountered by the lift arm or to structure connected to the lift arm. This acts as a safety clutch, but is likely to disrupt timing of the planet 16 to the ring member 22.

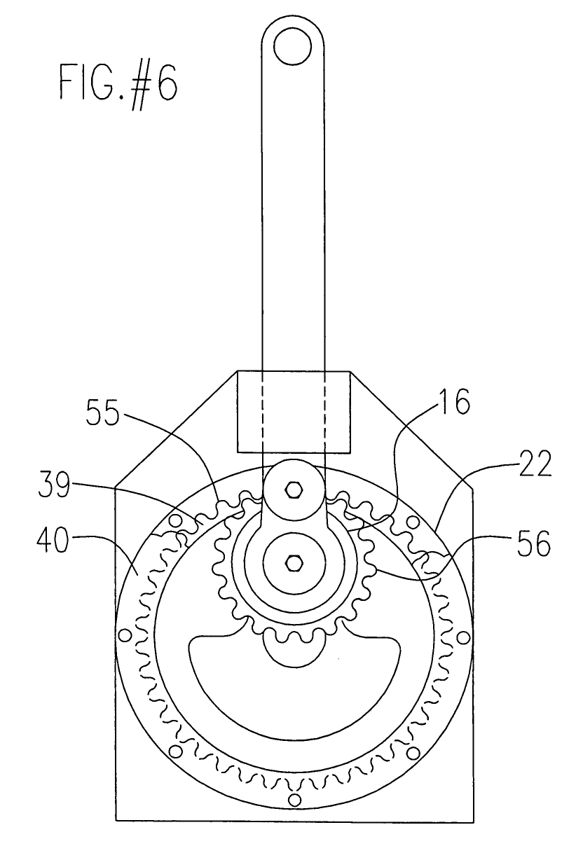

A second embodiment is shown in FIG. 6 and has yet another form of engagement between the planet wheel 16 and the ring member 22. That configuration is characterized by elastomeric teeth in a belt 55 extending around the circumferential channel between the rings 39 and 40. The planet wheel 16 has a rubber toothed outer circumference 56. This structure offers positive engagement between the planet wheel and ring member yet is also inexpensive to produce. Lubrication requirements are low to nonexistent. Because of the elastic nature of the meshing components, foreign matter including dirt, fibers and bits of insulation are also accommodated within the mechanism without causing failure. The configuration also runs exceedingly quietly and is low maintenance.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed and desired to be secured by Letters Patent is:

1. A hypocycloidal drive mechanism converting rotary to linear motion and comprising:
a) a rotary input shaft;
b) said rotary input shaft extending coaxially into a fixed outer ring sprocket having a cog chain extending there around and matched to the pitch of the outer ring sprocket;
c) a first crank arm secured to said rotary input shaft and having an outer end;
d) a crank shaft secured to said crank arm outer end;
e) a planet sprocket secured to an outer end of said crank shaft and traveling about the inner diameter of said outer ring sprocket as said rotary input shaft turns, the planet sprocket being meshed with the chain of said outer ring;
f) a second crank arm attached to and extending from the rotational axis of the planet sprocket;
g) a second crank shaft extending from an outer end of the second crank arm;
h) a linearly reciprocating shaft extending from said second crank shaft;
i) guide ways positioning said linearly reciprocating shaft; and
j) whereby said planet sprocket revolves within said outer ring sprocket and imparts a linear and revolving motion to said second crank shaft to cause said reciprocating shaft to move linearly.

2. A hypocycloidal drive mechanism comprising;
a) a rotary motion shaft driven by a power source;
b) the rotary motion shaft extending into an outer ring structure with an internal diameter formed by a roller chain matched to the pitch of the outer ring structure to form an internal sprocket;
c) a planet wheel connected to the rotary motion shaft via a crank and traveling about the inner diameter of the internal sprocket meshed therewith;
d) a second crank extending from the axis of said planet wheel and connected to a linearly reciprocating shaft for translating rotary motion to linear motion; and
e) guide ways positioning said linearly reciprocating shaft for linear motion.

3. The hypocycloidal drive mechanism set forth in claim 2 wherein said planet wheel is one half of the pitch diameter and internal circumference of said internal sprocket to provide linear motion of said linearly reciprocating shaft.

4. The hypocycloidal drive mechanism set forth in claim 2 wherein said planet wheel is one half the diameter and one half the circumference of said inner diameter raceway to provide linear motion of said linearly reciprocating shaft.

5. The hypocycloidal drive mechanism set forth in claim 5 wherein said planet wheel has an elastomeric face in smooth, friction, engagement with said inner diameter raceway.

6. A hypocycloidal drive unit comprising:
a) a rotating output shaft driven by an electric motor;
b) the output shaft extending into an outer ring structure with an internal diameter formed by a roller chain extending around the outer ring structure;
c) a crank secured to output shaft and having a planet sprocket rotatably mounted to an end thereby and rollable around the interior of said outer ring structure meshed with said roller chain, the planet sprocket being one half the diameter and circumference of said ring structure internal diameter;
d) a second crank extending from the axis of said planet sprocket and connected to a linearly reciprocating shaft for translating rotary motion to linear motion; and
e) guide ways position said linearly extending shaft for linear motion.
